(19) United States
(12) Patent Application Publication
(10) Pub. No.: US 2007/0094160 A1
(43) Pub. Date: Apr. 26, 2007

(54) MAN-MACHINE INTERFACE

(75) Inventors: David Victor Keyson, Amstelveen (NL); Philip Roland Ross, Delft (NL); Martijn Hugo Vastenburg, Delft (NL); Nicole Maria De Koning, Voorburg (NL)

Correspondence Address: PEACOCK MYERS, P.C., 201 THIRD STREET, N.W., SUITE 1340, ALBUQUERQUE, NM, 87102, US

(73) Assignees: Technische Universiteit Delft, Delft (NL); TNO Telecom, Delft (NL)

(21) Appl. No.: 11/530,324

(22) Filed: Sep. 8, 2006

Related U.S. Application Data
(63) Continuation-in-part of application No. PCT/NL05/00170, filed on Mar. 8, 2005.

(30) Foreign Application Priority Data
Mar. 8, 2004 (NL) NL 1025661

(51) Int. Cl. G06F 15/18

(52) U.S. Cl. 706/12

(57) ABSTRACT

An interface for maintaining man-machine communication with a control system for tuning appliances that influence the ambience, wherein a user command given during operation is converted to settings of these appliances in accordance with at least one predetermined conversion model, wherein the conversion model is a three-dimensional one, with parameter axes that refer to predetermined aspects of ambience, and in that the conversion model possesses adjustable discrete values pertaining to these aspects of ambience, and that the model provides an unambiguous interrelation that is continuous between said discrete values, linking a user command to the ensuing settings of the appliance depending on said values of the ambience aspects and the given user command.

### CROSS-REFERENCE TO RELATED APPLICATIONS

This application is a continuation-in-part application of Patent Cooperation Treaty (PCT) Patent Application Serial No. PCT/NL2005/000170, entitled “Man-Machine Interface”, to Technische Universiteit Delft and TNO Telecom, filed on Mar. 8, 2005, and the specification and claims thereof are incorporated herein by reference.

This application claims priority to and the benefit of the filing of Netherlands Patent Application Serial No. 1025661, entitled “Man-Machine Interface”, filed on Mar. 8, 2004, and the specification and claims thereof are incorporated herein by reference.

### BACKGROUND OF THE INVENTION

1. Field of the Invention (Technical Field)

The invention relates to an interface for maintaining man-machine communication with a control system for tuning appliances that influence the ambience, wherein a user command given during operation is converted to settings of these appliances in accordance with at least one predetermined conversion model.

2. Description of Related Art

Such an interface is known from EP-A-0 495 305 and U.S. Pat. No. 5,086,385. The known interface relates in essence to a computerized switch system.

Such an interface is also known from the Haagse Courant (The Hague Newspaper) dated 18 Jul. 2003.

In said Haagse Courant, under the heading “Spa to stimulate meeting addicts”, a meeting room is disclosed whose color can be changed deliberately by the user, that can acquire a different smell and in which predetermined music can be played.

### BRIEF SUMMARY OF THE INVENTION

By means of remote control, the ambience-influencing appliances can be tuned to a selection of six predetermined atmospheres. To this end a chairman of a meeting can use different colors of light, music, scent and appropriate images on the projection screen, to find an association with the various phases through which a meeting progresses, such as forming ideas, negotiations, deepening understanding, relaxation, decision making and kindling enthusiasm. The various atmospheres may be complemented by selected refreshments.

A drawback of the known interface is that it only differentiates between six predetermined atmospheres, so that it is not always possible to optimally attune to the requirements of the users.

### DETAILED DESCRIPTION OF THE INVENTION

The object of the invention is to provide a variant of the known interface that better meets the requirements existing in practice, and with which advantages can be achieved that will be made apparent hereinafter.

Those advantages include, among others, a more natural, simpler man-machine communication that can be tuned to—the personality of the user.

To this end the interface according to the invention is characterized by one or several of the appended claims.

In a first aspect of the invention, the interface is characterized in that the conversion model is a three-dimensional one, with parameter axes that refer to predetermined aspects of ambience, and in that the conversion model possesses adjustable discrete values pertaining to these aspects of ambience, and that the model provides an unambiguous interrelation that is continuous between said discrete values, linking a user command to the ensuing settings of the appliance depending on said values of the ambience aspects and the given user command.

Embodying the conversion model three-dimensionally renders controlling more transparent, effectively linking up with the ambient world as perceived by the user. The conversion model is preferably embodied such that parameter axes are provided for the variables warmth, attention and activity. It is these parameters in particular that afford an effectively working system.

The interface according to the invention allows the user to tune the ambience exactly and above all simply to the needs existing for the user at any moment in time. When in-stalled in a living room, a user is able to select preset atmospheres, but it is also possible to make new combinations by combining settings. For example, the user can select a romantic atmosphere and subsequently ask for a “warmer” atmosphere. The conversion model then combines the available con-tent in a new atmosphere setting.

The fact that there is a group of conversion models and that the user is able to selectively activate a conversion model from this group, serves to widen the range of applicability of the interface according to the invention.

It is further advantageous, for at least one conversion model from the group of conversion models to be of a predetermined nature determined by a selection from the group comprising atmosphere, occasion, ethnicity, geographical origin.

In order to be able to comply more effectively with the wish of exactly tuning the atmosphere to the needs of the user, at least one conversion model is adjustable. In this way the user can tune the settings of the appliances influencing the ambience to his needs case by case and, as it were, personalize them.

To further the user-friendliness of the interface according to the invention, the same can be connected to an output device for displaying the ensuing settings of the appliances influencing the ambience after a given user command.

Hereinafter the invention will be further elucidated by way of an exemplary embodiment and with reference to the drawing, without limiting the appended claims. The drawing shows a single figure, schematically il-lustrating the interface according to the invention, including peripheral equipment.

The interface according to the invention serves to enable a user to quickly tune a number of appliances influencing the ambience, e. g. a video system, an audio system and a lighting system. All these systems are able to contribute to a desired atmosphere. The interface according to the invention is primarily intended for creating a desired atmosphere, although the interface may also be used as a management system for the peripheral equipment.

The interface according to the invention is able to provide several themes such as atmospheres, occasions and ethnically-or geographically-related backgrounds. For each such theme a separate conversion model may be provided in which the change relations between user commands and the adjustments of the settings of the appliances influencing the ambience, are fixed.

### BRIEF DESCRIPTION OF THE DRAWINGS

FIG. 1 shows the interface 1 according to the invention, which at the input side may be provided with a speech recognizer 2, a tangible interface in the form of, for example, a keyboard, light switches 4 and a graphical user inter-face. With this peripheral equipment 2-5, the interface 1 can be operated and controlled and it allows navigation among the atmospheres to be created. At the output side, the interface 1 controls a video generator 6, a light controller 7 and an audio player 8. The video generator 6 reads and manipulates video files and transmits video signals to a video projector 9. The light controller 7 controls the light in a room whose ambient conditions are influenced by the interface, and transmits appropriate commands to light dimmers 10. To the audio player 8 an audio surround-sound system 11 is connected.

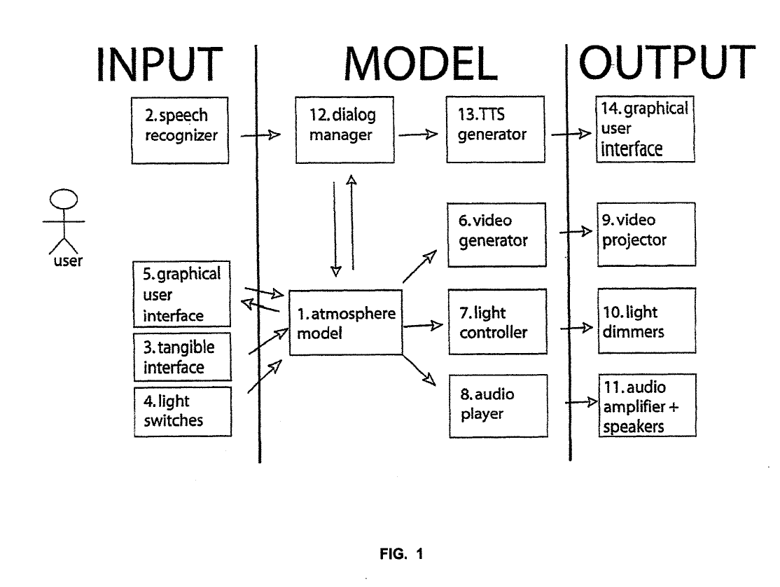

The speech recognizer 2 further serves for converting the spoken word in accordance with predetermined word commands to a dialogue manager 12, with which the interface 1 can be controlled. To support this objective, there may also be a things to say generator 13, which visualizes the possible verbal commands via a graphical display unit 14.

The interface 1 provides conversion models with which it is possible to dynamically control the ambience-influencing appliances 6, 7 and 8 connected to the interface.

The user is enabled to simply navigate through a three-dimensional space created by the conversion model that possesses the parameter axes warmth, attention and activity. In addition, the user can personalize the conversion model by adding, relocating or removing media content, which is determining for the ambience-influencing appliances 6, 7 and 8. In addition, the user may bestow own names on the conversion models to be used.

It goes without saying that the interface 1 is constantly aware of the status of the connected appliances 6, 7 and 8 with respect to the sound that is produced, the light settings, the active video presentation. The interface 1 can also monitor, and if necessary store which changes, additions or removals the user implements in a particular conversion model.

The interface 1 is preferably also provided with a unit for recording day, time, season, date and optionally the number of users present, and the activities they are to engage in. For this latter purpose, for example, an organizer may be provided and connected to the interface 1.

Finally, it is desirable for the interface 1 to be connectable to an output device such as a monitor or display for showing the ensuing settings of the ambience-influencing appliances after a given user command.

What is claimed is:

1. An interface for maintaining man-machine communication with a control system for tuning appliances that influence the ambience wherein a user command given during operation is converted to settings of these appliances in accordance with at least one predetermined conversion model, said interface comprising:
at least one three-dimensional conversion model, with parameter axes that refer to predetermined aspects of ambience, wherein the conversion model possesses adjustable discrete values pertaining to these aspects of ambience, and
wherein the model provides an unambiguous interrelation that is continuous between said discrete values, linking a user command to the ensuing settings of the appliance depending on said values of the ambience aspects and the given user command.

2. An interface according to claim 1, wherein at least one conversion model has the parameter axes warmth, attention and activity.

3. An interface according to claim 1, wherein there is a group of conversion models and the user is able to selectively activate a conversion model from this group.

4. An interface according to claim 1, wherein at least one conversion model is of a predetermined nature selected from the group consisting of atmosphere, occasion, ethnicity, and geographical origin.

5. An interface according to claim 1, wherein at least one conversion model is adjustable.

6. An interface according to claim 1, additionally comprising a speech recognizer for processing spoken user commands.

7. An interface according to claim 1, additionally comprising connection to an output device for displaying the ensuing settings of the appliances influencing the ambience after a given user command.
